(19) United States
(12) Patent Application Publication
(10) Pub. No.: US 2005/0066002 A1
(43) Pub. Date: Mar. 24, 2005

(54) Workflow compatible healthcare information message communication system

(76) Inventors: Arnold Teres, Broomall, PA (US); Brian DelMonego, Chester Springs, PA (US)

Correspondence Address: Alexander J. Burke, 170 Wood Avenue South, Intellectual Property Department 5th Floor, Iselin, NJ, 08830, US

(21) Appl. No.: 10/903,383

(22) Filed: Jul. 30, 2004

Related U.S. Application Data
(60) Provisional application No. 60/491,639, filed on Jul. 31, 2003.

(51) Int. Cl. G06F 15/16

(52) U.S. Cl. 709/204

(57) ABSTRACT

A system and method is disclosed for providing a single portable and consistent non-proprietary interface between proprietary systems that are required to be integrated to facilitate workflow integration (i.e., the communication of data and messaging). The system includes a communication processor that receives a message from a first information system in a first data format and identifies the type of message received. The communication processor selects a particular message data format and a message destination from a plurality of message destinations based on the identified message type and the source of the received message. The communication processor converts the received message from the first data format to a different, i.e., second, data format to be communicated, via a communication interface, to a destination information system. The communication processor communicates the converted data in the different, i.e., second, data format to a destination information system. The system of the invention further includes a repository of information identifying a plurality of different message data formats associated with a corresponding plurality of different healthcare information system communication interfaces and wherein the communication processor selects the particular message data format and the destination, using the repository.

### CROSS REFERENCE TO RELATED APPLICATIONS

This is a non-provisional application of provisional application Ser. No. 60/491,639 et al. filed Jul. 31, 2003.

### TECHNICAL FIELD

The present invention relates generally to workflow integration, and more particularly, to a system and associated method for supporting message communication between systems employing different proprietary communication message data formats.

### DESCRIPTION OF RELATED ART

In the field of radiology and diagnostic imaging, tight integration between systems is a pre-requisite to providing an efficient and cost effective environment for the generation of diagnostic results (documents which describe what a diagnostic image portrays and how that portrayal should be considered during diagnoses). For example, a diagnostic result for a CT scan of the head may state that the diagnostic image reveals a radio-opaque mass indicative of a non-malignant tumor.

Generally, the steps involved in producing a diagnostic result document include the production of at least one diagnostic image of a patient, an analysis of the obtained images, the retrieval and analysis of any previous diagnostic images which may have relevance to the current diagnosis, and a dictation by a radiologist evaluating the relevant images for later transcription. To carry out the aforementioned steps, three different systems are utilized (1) A picture archiving and communication system (PACS), used to view a patient's current and prior diagnostic images (2) A radiology information system (RIS), used to view a patient's prior results and procedures to add clinical background to the interpretation of the patient's current diagnostic images displayed on the PACS and (3) A dictation system used by the radiologist to produce a recorded dictation for later transcription. The dictation system often provides speech recognition technology to eliminate the need for manual transcription of the dictation into a result document.

The RIS, PACS and dictation system may be used in different workflow configurations to produce result documents from diagnostic images. More particularly, one workflow configuration for producing diagnostic result documents from diagnostic images is referred to as a “PACS drives RIS” workflow. Another workflow configuration for producing the same diagnostic result document is referred to as an “RIS drives PACS” workflow.

FIG. 1a illustrates the “RIS drives PACS” workflow configuration 100. In this workflow configuration, a radiologist uses the RIS 4 (i.e., the device for viewing a patient's prior results) as the primary workspace to move from patient to patient. The PACS 2 and dictation system 6 are controlled by the RIS 4. That is, for a patient selected by the RIS 4, the PACS 2 displays that patient's diagnostic images and the dictation system 6 records and translates the proper procedure. In essence, the PACS 2 and the dictation system 6 are slaves to the RIS 4 directing how the PACS 2 and dictation system 6 should operate.

Referring now to FIG. 1b, the second workflow configuration is shown, i.e., the “PACS drives RIS” workflow configuration 150. In this configuration, the radiologist uses the PACS 2 as the primary workspace to move from patient to patient. The RIS 4 and the dictation system 6 are slaves to the PACS 2, directing how the RIS 4 and dictation system 6 should operate.

One drawback of the two configurations described above is that workflow integration between the various systems (i.e., RIS, PACS and dictation system) is complicated by a lack of standards and common technologies. Moreover, the workflow configurations rely on proprietary technologies that are neither re-usable nor portable. Specifically, a RIS typically operates with a PACS and dictation system that are both manufactured by different vendors. As such, the interfaces between the RIS and PACS utilize technologies and data formats that are developed to meet the needs of the various vendors and are based on the perceived needs of those vendors and not on the needs of the RIS or the entire suite of integrated components. This results in an environment in which interoperability is difficult and expensive to engineer. Unlike other facets of the health care industry, there are no governing bodies or standards to reconcile the conflicting technologies and data formats. Without such standards, an RIS vendor is forced to develop a new interface for each PACS vendor and dictation system vendor. Therefore, a significant investment in terms of human resources is spent on writing and testing new interfaces, and a long period of time is required for attaining an acceptable level of reliability. This causes delays and high costs. To further compound the problem, the PACS and/or dictation system vendors sometimes have different interfaces for different models and releases, which serves to increase the number of proprietary interfaces that an RIS developer is required to develop and maintain.

Another disadvantage of prior art systems is that because a large number of disparate technologies are used in the workflow integration interfaces, the complexity of the radiology product increases and the ability to provide consistent and reliable workflow behavior decreases.

A further disadvantage is the difficulty in configuring the interfaces when workflow integration has to operate on different computers. For example, the use of file-based interfaces becomes extremely difficult to configure when two different computers using two different operating systems are on either end of the interface.

Accordingly, there is a need for a solution that allows an RIS developer to integrate an RIS device with foreign devices using an open interface technology to preclude the need to develop a multitude of proprietary customized RIS interfaces for use with foreign devices to provide workflow coordination.

### SUMMARY OF THE INVENTION

The present invention overcomes the above-noted and other deficiencies of the prior art by providing a system and method that provides a single portable and consistent non-proprietary interface between proprietary systems that are required to be integrated to facilitate workflow integration (i.e., the communication of data and messaging).

A system of the invention includes a communication processor that receives a message from a first information system in a first data format and identifies the type of message received. The communication processor selects a particular message data format and a message destination from a plurality of message destinations based on the identified message type and the source of the received message. The communication processor converts the received message from the first data format to a different, i.e., second, data format to be communicated, via a communication interface, to a destination information system. The communication processor communicates the converted data in the different, i.e., second, data format to a destination information system. The system of the invention further includes a repository of information identifying a plurality of different message data formats associated with a corresponding plurality of different healthcare information system communication interfaces and wherein the communication processor selects the particular message data format and the destination, using the repository.

### BRIEF DESCRIPTION OF THE DRAWINGS

Referring now to the drawings in which like reference numbers represent corresponding parts throughout, where:

FIG. 1a is a high level block diagram illustrating a generic system configuration for a “RIS drives PACS” workflow configuration;

FIG. 1b is a high level block diagram illustrating a generic system configuration for a “PACS drives RIS” workflow configuration;

FIG. 2 is a functional block diagram illustrating an exemplary healthcare information message communication system including the system of the invention;

FIG. 3 is a flowchart diagram of a method of utilizing the interface system of the invention in accordance with an exemplary embodiment; and

FIG. 4a is a high level block diagram illustrating a system configuration for a “RIS drives PACS” workflow configuration;

FIG. 4b is a flow diagram that illustrates the correspondence between the “RIS drives PACS” integrated workflow system configuration of FIG. 4a and the general workflow description described in the flowchart of FIG. 3

FIG. 5 is an exemplary workflow diagram that describes the workflow that may occur between the various system elements, i.e., the workflow between the RIS and one or more foreign systems during a “log on and first procedure access”;

FIG, 6 is an overview of the operational steps in flow diagram form, of an embodiment of a method for supporting message communication between healthcare information systems employing different communication message data formats;

FIG. 7a illustrates an exemplary event map database identifying the transactions that are exchanged between the various systems at the workflow (integration) points for a particular installation;

FIG. 7b illustrates a transaction definition database that defines the event transactions in terms of the discrete data elements that comprise the transactions as well as their data types and transformations required to keep the data compatible when exchanged between the various systems;

FIG. 8 illustrates a system configuration that includes an RIS Simulator in place of an actual RIS;

FIG. 9 is a display image window of one embodiment of an RIS simulator display screen 900 which is displayed in response to user command.

FIG. 10 is the display image window of FIG. 9 further illustrating how various messages are sent from RIS simulator to the PACS and the Speech Dictation/Recognition System;

FIG. 11 is the display image window of FIG. 9 further illustrating how various messages are received by RIS Simulator from the PACS and the Dictation System;

FIG. 12 is the display image window of FIG. 9 further illustrating a case in which the RIS simulator has received additional messages from the speech dictation/recognition system;

FIG. 13 is a display image window of one embodiment of a trace screen that is shown to a user in response to the user clicking on the “View Trace” icon of FIG. 12.

### DETAILED DESCRIPTION OF THE INVENTION

A system and method is provided for message communication between information systems employing different communication message data formats (i.e., having proprietary interfaces) thereby precluding the need to develop a multitude of customized interfaces.

The system and method is suitable for use in any data processing context in which two or more systems, employing different proprietary interfaces, require workflow integration. The system and method further provides an opportunity in certain cases to re-use development code to meet the needs of future customers with related or identical interface requirements. It should be appreciated in the prior art, workflow integration relied on proprietary technologies that are neither re-usable nor portable.

The system and method has particular but not exclusive application to healthcare information message communication systems, and it is in this context that the present invention is described.

In implementing the system and method there are several advantages realized over prior art proprietary implementations. A first advantage is that the system and method provides a single portable and consistent interface that allows a radiology information system (RIS) to interface with one or more foreign systems, such as, for example, a picture archiving and communications system (PACS) or a dictation system, without the need to understand the proprietary aspects of the foreign systems. The proprietary requirements of the foreign systems are isolated from the RIS by virtue of utilizing an open interface design. Isolating the RIS in this manner provides numerous advantages over the prior art including decreasing the complexity of the RIS, eliminating the need to reconstruct the RIS when incompatibilities are introduced by new software versions of the interfaced systems or different interfaced systems, decreasing the amount of new code required when developing new interfaces, an increased flexibility in the supported hardware architecture of the interfaced systems thus allowing workflow integration on the same or different computers and simplifying development and testing by using an RIS simulator in conjunction with a standard development process.

The disclosed elements to be described herein may be comprised of hardware portions (e.g., discrete electronic circuitry), software portions (e.g., computer programming), firmware or any combination thereof.

One of skill in the art can appreciate that the display image windows illustrated in the figures represent one possible arrangement and that other arrangements may be used which may include several image windows in place of one image window illustrated in the figures, or conversely one image window to represent several image windows, or different image window arrangements.

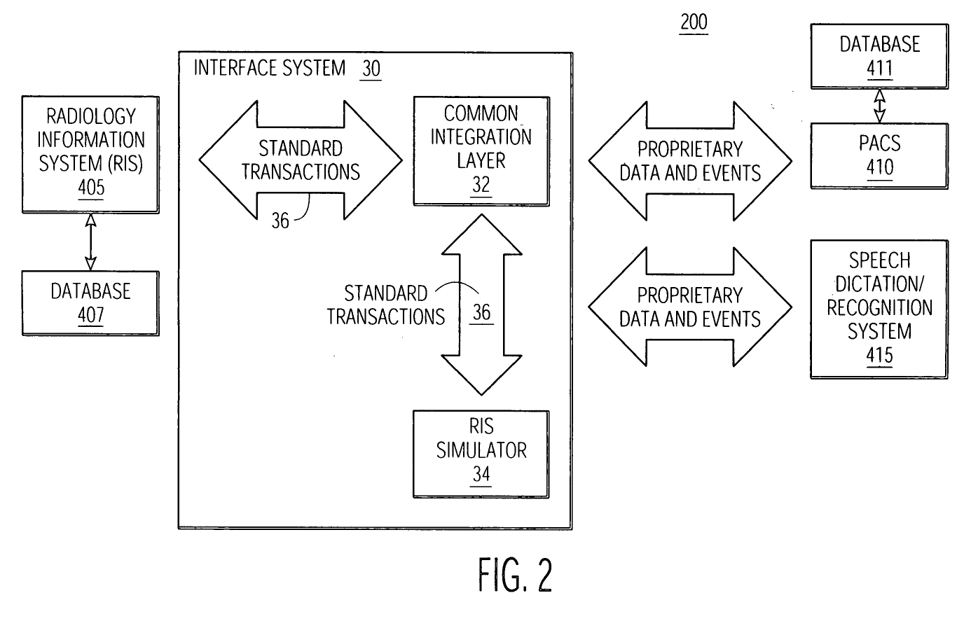

FIG. 2 is a functional block diagram illustrating an exemplary healthcare information message communication system 200. In the FIG. 2 system, three major components are shown, a radiology information system (RIS) 10, the interface system 30 and a foreign system 40, which could represent, for example, a PACS system or a dictation system. The FIG. 2 system serves to provide workflow integration for the purpose of providing diagnostic radiology services to a healthcare enterprise (e.g. a hospital or diagnostic imaging center).

The interface system 30 is a communication processor comprised of a common integration layer 32, a set of standard transactions 36 sent and received by the RIS 10 through a variety of standard transports and an RIS simulator 34. A communication processor as used as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. An object as used herein comprises a grouping of data, executable instructions or a combination of both or an executable procedure.

The manner in which the interface system 30 is utilized to facilitate communication between the RIS 405 and one or more foreign systems 410, 415 employing different proprietary communication message data formats is now described.

To optimize the message (or data) flow between the RIS 405 and one or more foreign systems 410, 415, a work-flow integration is mapped out between the RIS 405 and the one or more foreign systems 410, 415. The process of mapping out a work-flow integration may be conducted through the use of workflow diagrams to determine which standard transactions 36 need to be sent and received between the RIS 405 and the one or more foreign systems 410, 415 which interface with the RIS 405 during the normal course of operation. The standard transactions 36 which are ultimately chosen to include in the interface system 30 generally represent a superset of the transactions used by the one or more foreign systems 410, 415 which may potentially be employed for use with the RIS 405.

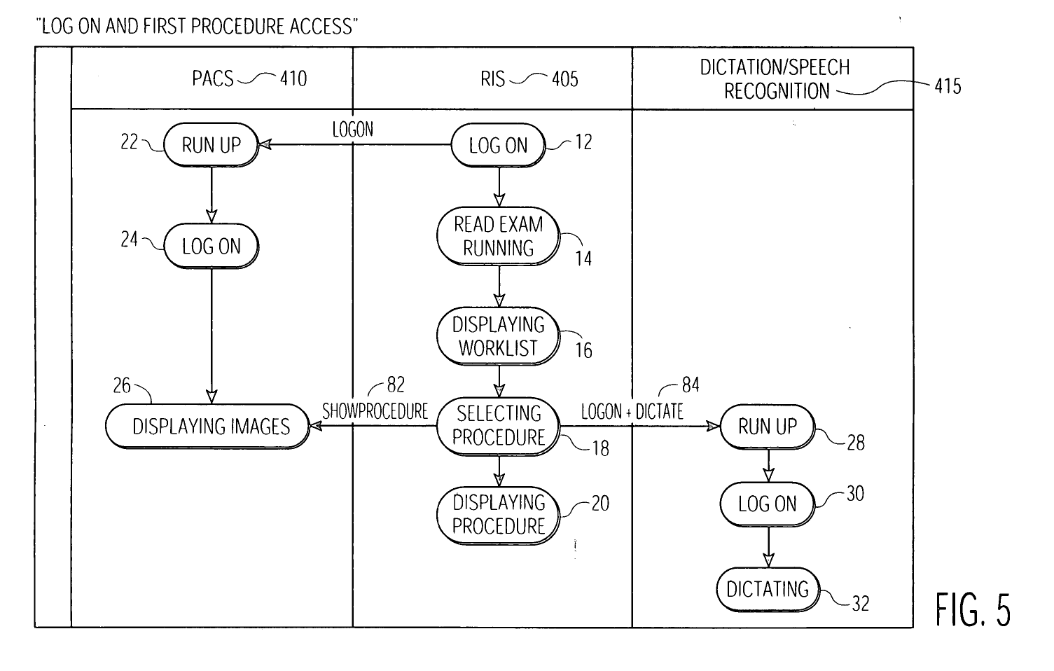

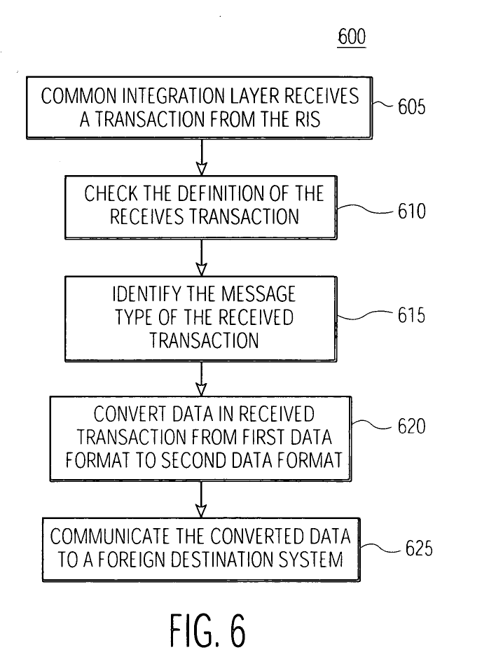

Workflow diagrams are described in greater detail with reference to FIG. 5. It is noted that in the overall hierarchy of events, workflow diagrams are specific in nature and are generated as the end products of a top level flow diagram of the operational steps performed by a diagnostic system.

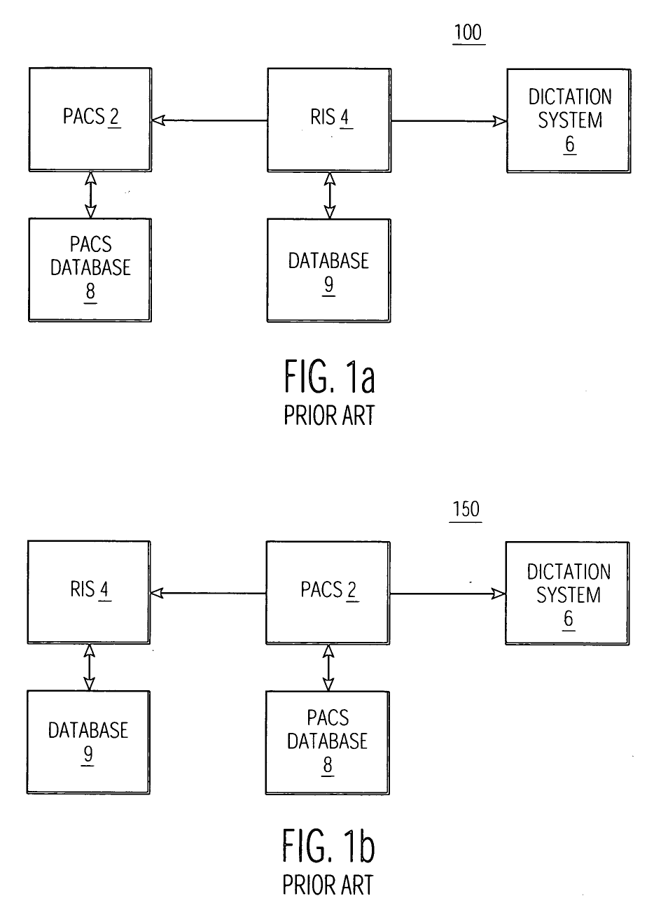

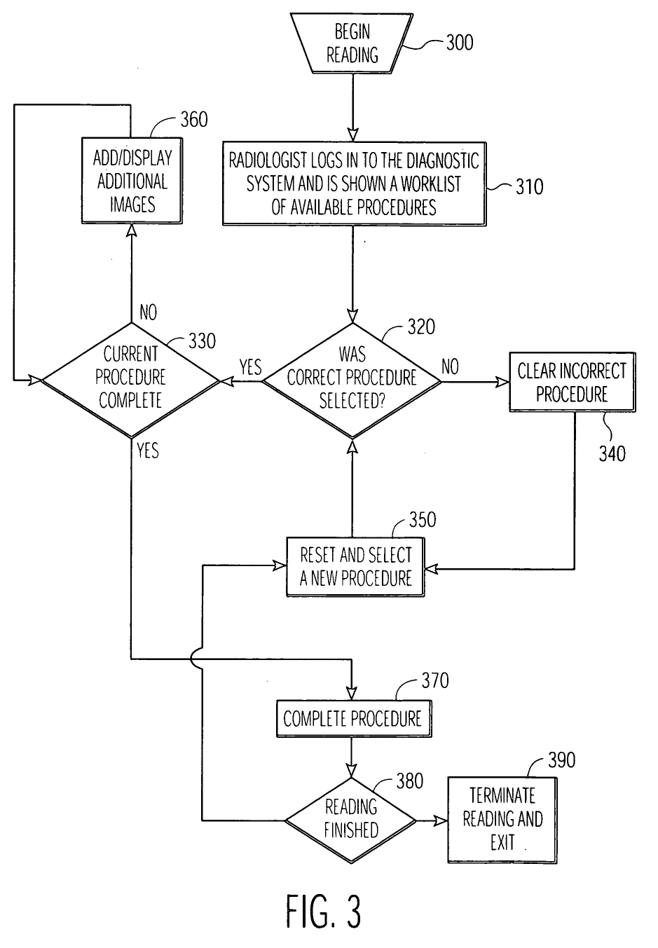

FIG. 3 shows an exemplary top level flow diagram of the operational steps performed by a diagnostic system. The flow diagram of FIG. 3 is generic in that it equally describes either a “RIS drives PACS” workflow (as shown in FIG. 1a) or a “RIS drives PACS” workflow (as shown in FIG. 1b). Typically, one or more workflow diagrams are constructed from the top level flow diagram of FIG. 3. The workflow diagrams, once constructed, may then be used to identify a superset of standard transactions 36 for use in the interface system 30.

The top level system workflow description of FIG. 3 describes a general workflow description for a wide range of system configurations. The workflow description of FIG. 3 is provided to illustrate that the general workflow description is used to construct workflow diagrams for particular system configurations such as the “RIS drives PACs” system configuration of FIG. 1a or the “PACS drives RIS” system configuration of FIG. 1b.

The top level flow diagram of FIG. 3 detailing the generic operational steps performed by a diagnostic system, is now described.

At act 300 of FIG. 3, a radiologist interpreting diagnostic images accesses a computer running the RIS software (not shown) and starts a portion of the RIS 405 that is used for diagnostic interpretation. It is noted that, other portions of the RIS application may be used for performing non-diagnostic functions. An executable application as used herein comprises code or machine readable instruction for implementing predetermined functions including those of an operating system, healthcare information system or other information processing system, for example, in response user command or input.

At act 310, the radiologist logs on to the diagnostic system and is shown a work-list of available procedures capable of being performed by the diagnostic system. The procedures are obtained from an RIS database 407 associated with the RIS 405 (as shown in FIG. 2). The radiologist selects a procedure from the displayed work-list.

Act 320 is a determination step to determine whether the procedure selected at act 310 has been correctly selected. Because the radiology procedure is selected by a manual action (typically a user initiated mouse click or a key stroke) it is possible that the selected procedure is not actually the procedure that the radiologist intended to select. If it is determined that a procedure is incorrectly selected at this act, the process continues at act 340 to clear the incorrect procedure. It should be noted that subsequent to selecting a procedure, the radiologist has the option of clearing the selected procedure, at act 340, or to optionally add additional images to a correctly selected procedure, to be described at act 360.

At act 340, the procedure selected by a user is determined to be an incorrect procedure, either through error or because the images for the procedure are unacceptable for some reason. The selected procedure is cleared at this act and the process continues at act 350.

At act 350, a new procedure is selected. It is noted that the processing of a first selected procedure is different than the processing subsequently selected procedures. For example, for the first selected procedure, the RIS 405 needs to log in to and possibly launch the PACS 410 and/or dictation system 415. For subsequently selected procedures these tasks do not need to be repeated. The process returns to act 320 after act 350.

Act 330 is a determination act that is performed when a correct procedure is selected by the radiologist at act 320. Act 330 determines whether the currently selected procedure is complete. That is, if in the radiologist's judgment, additional images are required to make a diagnosis, the procedure is considered incomplete and the process continues at act 360. Otherwise the process continues at act 370.

At act 360, the images that are loaded by default may not be sufficient to fully interpret the clinical situation. In this case, the radiologist decides to view additional images to assist with the clinical interpretation. The RIS 405 provides a mechanism that allows the user to know what prior results include images that may be pertinent. When the additional images have been displayed, the process returns to act 330.

Act 370, at this point, an action “complete procedure” is a transaction that informs the PACS 410 to mark a procedure as complete in the PACS database 411 (i.e. the procedure has been read by the radiologist and interpretation is finished).

At act 380, it is determined whether the reading is finished. If so, the process terminates at act 390, otherwise the process continues at act 350.

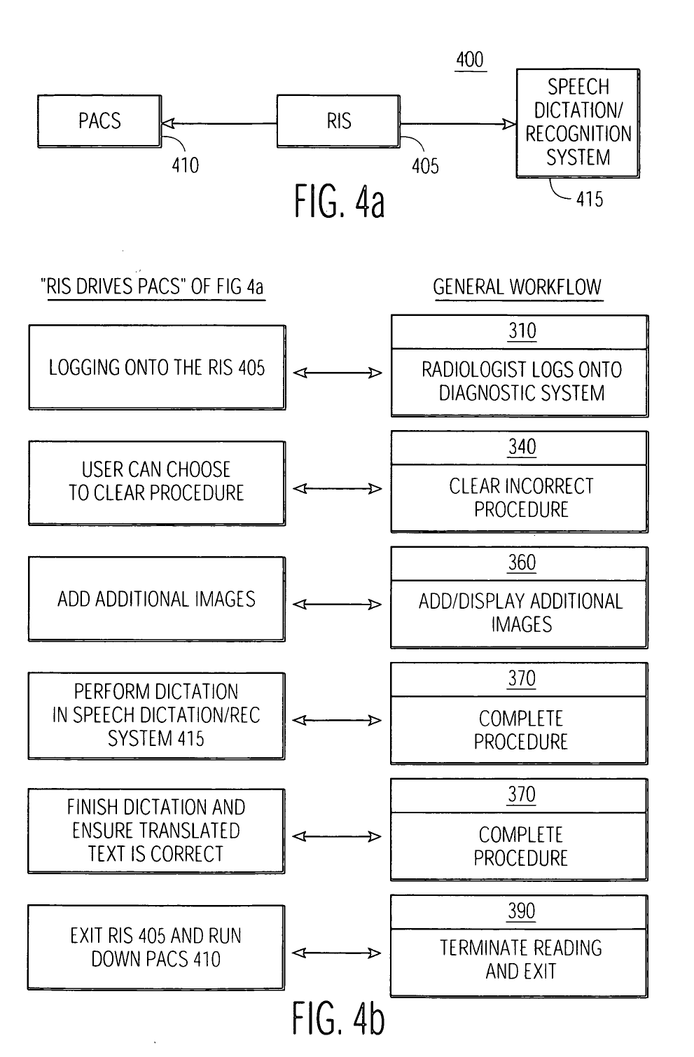

FIG. 4a illustrates a particular workflow system configuration, namely, a “RIS drives PACS” integrated workflow system configuration 400. This particular workflow configuration is used to illustrate how the general workflow description described in the flowchart of FIG. 3 may be used to create workflow diagrams specific to the particular workflow configuration.

FIG. 4b is a flow diagram that illustrates the correspondence between the “RIS drives PACS” integrated workflow system configuration of FIG. 4a and the general workflow description described in the flowchart of FIG. 3.

Referring to FIG. 4b, the processes specific to the “RIS drives PACS” configuration of FIG. 4a and the corresponding processes of the general workflow description described in the flowchart of FIG. 3 are: logging on to the RIS (corresponding to act 310); after a procedure selection by the user, the user can choose to clear the procedure (corresponding to act 340) or add additional images (corresponding to act 360); the user verbally dictates a result that is converted into written text after the images are displayed. This occurs on the speech dictation/recognition system 415. Dictation is usually performed while the radiologist is looking at images (corresponding to act 370); the user completes the report in the speech dictation/recognition system 415 by finishing the dictation and ensuring that the translated text is correct (corresponding to act 370); the user exiting the RIS 405, thereby signaling that the PACS 410 and speech dictation/recognition system 415 should be logged off and/or run down. (corresponding to act 380)

For the processes specific to the “RIS drives PACS” configuration illustrated in FIG. 4b and described above, the RIS 405 needs to exchange messages with both the PACS 410 and the speech dictation/recognition system 415. A number of workflow diagrams may be constructed to highlight the messaging that needs to be exchanged, one example of which is provided as follows.

FIG. 5 is an example of one of the many workflow diagrams constructed to highlight the messaging that needs to be exchanged between the various system elements of FIG. 4a. Specifically, the workflow diagram 500 of FIG. 5 describes the workflow between the RIS 405, the PACS 410 and the speech dictation system 415 of FIG. 4a for the “log on and first procedure access” process generically described at act 310 of the general workflow description of FIG. 3.

The workflow diagram of FIG. 5 is shown to be generally divided into three separate columns representing the various devices in the system. Specifically, the PACS system 410 in shown to be associated with the first column, the RIS system 405 is shown to be associated with the second column and the speech dictation/recognition system 415 is shown to be associated with the third (last) column. Additional system elements involve extending the current workflows (i.e., additional column(s)) to include the additional system elements. The system accommodates this extensibility.

As shown, the workflow diagram 500 of FIG. 5 includes actions and transactions. The actions are generally denoted in bubbles, such as, for example, the “log on” action, including three instances denoted by labels 12, 24 and 30, the “Read Exam Running” action denoted by label 14, the “displaying worklist” action denoted by label 16 and the “selecting procedure” action denoted by label 18 and so on.

The transactions for communicating data messages, associated with the various actions between the various system elements are generally denoted by directional arrows, three of which are shown: the “LogOn” transaction 80, the “ShowProcedure” transaction 82 and the “Logon and Dictate” transaction 84.

The “Logon” 80 transaction (located in the upper left of the workflow diagram) is a message communication that occurs between the RIS 405 and the PACS 410 at the point in time where a user logs on to the RIS 405. At this time, the RIS 405 issues a “Logon” 80 indication to the PACS 410 which causes the PACS 410 to “run up” 22.

The “ShowProcedure” transaction 82 is a message communication issued by the RIS 405 to the PACS 410 at the point in time at which the RIS 405 selects a procedure (see the “selecting procedure” 18 action in the workflow diagram). Upon receiving the “ShowProcedure” 82 transaction at the PACS 410, the PACS 410 displays images associated with the currently selected procedure.

The “Logon & Dictate” transaction 82 is a message communication issued by the RIS 405 to the Speech Dictation/Recognition System 415 at the point in time at which the RIS 405 selects a procedure 18 (see the “selecting procedure” 18 action in the workflow diagram). The “Logon & Dictate” transaction 82 when received by the Speech Dictation/Recognition System 415, causes it to run up 28 (i.e., boot up).

The standard set of transactions 36, which is one element of the interface system 30 of FIG. 2, are identified by reviewing the constructed workflow diagrams and selecting from the workflow diagrams, certain transactions from the workflow diagrams for inclusion. Those transactions that are selected for inclusion in the standard set of transactions 36 depend on the events that the RIS simulator 405 and the speech dictation/recognition system 415 support for the particular installation. For example, for a particular installation, the PACS system may not support appending images, so there is no need to send an append image transaction.

In one embodiment, the transactions selected from the workflow diagrams for incorporation into the standard transactions 36 are sent and received by the RIS simulator 405 through a standard set of named pipes. Named pipes are a technology developed by Microsoft that supports communications between programs running on any one of the following operating systems: Windows 2000, NT, 95, 98, 16 bit, MS-DOS, POSIX and OS/2. The RIS 405 can use the combination of transactions and pipes to determine the exact nature of a workflow event. For example, a workflow event can be the PACS selecting a new patient or the dictation system completing a result document or the PACS should display a particular image. In actuality, the interface system 30 determines the exact nature of a workflow event on behalf of the RIS 405 by monitoring such events and responding on behalf of the RIS 405. The interface system 30 understands the required workflows and the nature of the data values and transports required to communicate properly with the foreign systems.

Referring now to FIG. 6, there is shown an overview of operational steps in flow diagram form, of an embodiment of a method for supporting message communication between healthcare information systems employing different communication message data formats.

At Act 605, the common integration layer 32 receives an event transaction. The transaction can be sent from a foreign system intended for the RIS 405 or sent by the RIS 405 intended for a foreign system. Irrespective of the source and destination, the event transaction involves a data exchange applicable for a current event.

At Act 610, check the definition of the received event transaction. At this act, a lookup is performed in the transaction definition database to determine the contents of the event transaction. This act provides the framing information, field sequence, data types, and delimiters.

At Act 615, the common integration layer 32 identifies the message type of the received event transaction and selects from an event map database 710 (defined hereafter), a message data format and message destination based on the identified message type and the source of the received message.

At Act 620, the common integration layer 32 then converts the data in the received event transaction from its original data format to a second data format that is compatible with a destination system element.

At Act 625, the common integration layer 32 communicates the converted data to the foreign destination information system.

The details of the flowchart of FIG. 6 are now described by way of example. Before describing the details, it is instructive, at this point, to first distinguish an event from an event transaction. An event, as defined herein, is a representation of a physical occurrence in the system, such as, for example, the display of additional images. In general, it represents a physical act such as selecting some number of procedures for display. An event transaction is associated with the physical event and conveys the data for the physical event (e.g., which procedures were selected for display). Event transactions are listed as entries in the event map database 710 which define the existing transactions for the current system configuration. In the present example, one entry in the event map database 710 that defines an event transaction for selecting some number of procedures for display (i.e., the event) would be “Appendimages”. Further, the transaction definition database 720 defines all of the possible formats for the identified event transaction.

In accordance with the present example describing the flowchart of FIG. 6, assume that the “AppendImages” event transaction is received by the interface system 30 from a PACS system (the source). This event transaction is intended for the RIS 405 (the destination).

The process of converting the data in the received event transaction (e.g., AppendImages) from its original data format to a second data format that is compatible with a destination system element (e.g., the RIS) is as follows.

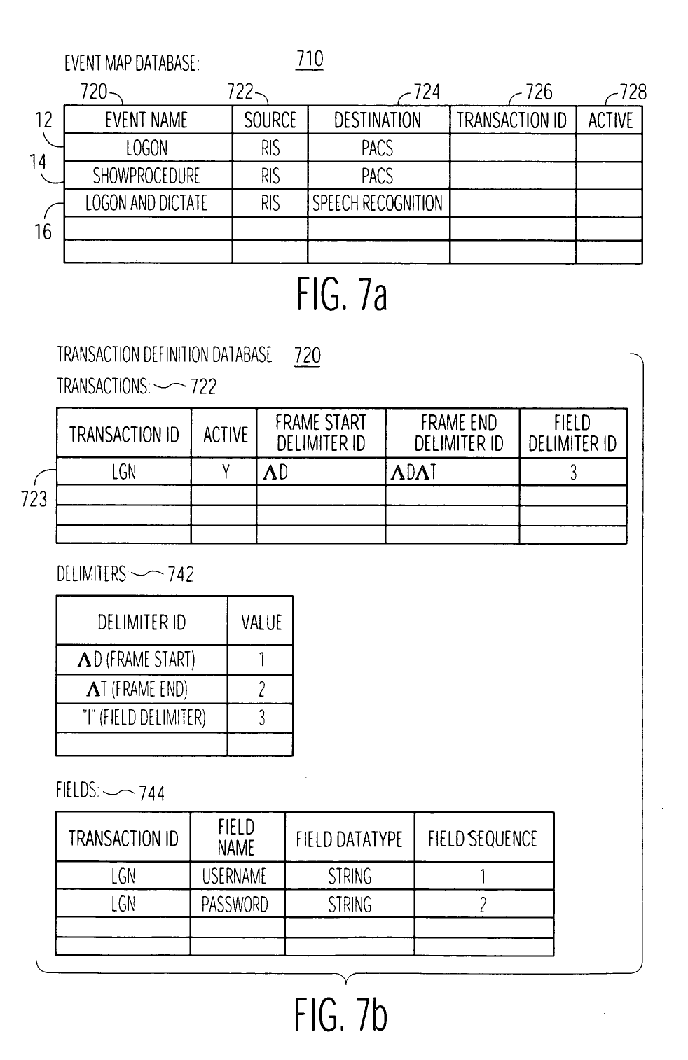

The common integration layer 32 component of the interface system 30 receives the “AppendImages” event transaction and begins to search for framing. The common integration layer 32 knows all of the frame start and frame end values by looking in a transaction database 720 (as shown in FIG. 7b and described hereafter). If valid framing if found then everything in between the frames constitutes the event transaction (i.e., the data being conveyed for the physical event.

Next, the transaction ID is located in the event transaction to identify the event. The transaction ID is used to look in the event map database 710 (as shown in FIG. 7a and described hereafter) for a matching transaction ID. If a match is found, the event that has taken place on the speech recognition system (i.e., foreign system) is identified allowing the event transaction data to be parsed.

The act of parsing the event transaction data is performed by the common integration layer 32 component of the interface system 30. The common integration layer 32 finds all of the fields defined in the transaction and performs a look up to determine how to convert the fields from a first data format to a second data format. Specifically, the common integration layer 32 includes a conversion routine for each data type defined in the transaction database 720 to convert that data type to the proper format and mechanism for each foreign system. The common integration layer 32 utilizes a hard coded lookup to determine which conversion routines are required on the basis of the datatype named in each field of the event transaction. Each field in each transaction is processed according to the lookup.

It is noted that new conversion routines and new choices in the lookup may be required for each new foreign system. However, some foreign systems can re-use currently defined conversion routines but as new systems emerge the technologies used for data communication may change resulting in the need for new conversions. The advantage in that there is only a need to produce new converters and not new workflows.

The event map database 710 has been referred to above and is now described as follows.

FIG. 7a illustrates an exemplary event map database 710 identifying the transactions (the messages exchanged at a particular workflow or integration point) that are exchanged between the various systems at the workflow (integration) points for a particular installation.

The event map database 710 defines the transactions which are installation dependent, i.e., site specific. That is, the event map database 710 is constructed during installation or site specific adaptation. For example, if a new dictation system is configured, the event map database 710 is used to “point” to the transactions used for the new dictation system.

The exemplary event map database 710 includes three exemplary transactions. A “logon” transaction 80 is listed in the first row 712 of the database 710, a “Showprocedure” transaction 82 is listed in the second row 714 and a “Logon & Dictate” transaction 84 is listed in the third row 716. It is noted that these particular transactions are applicable to the installation illustrated in FIG. 4a.

The columns of event map database 710 are now described. The first column, Event Name 720, identifies the event type, (e.g., a “Logon” transaction), the second column, Source 722, identifies the source of the transaction, (e.g., “RIS”), the third column, Destination 724, identifies the destination of the transaction, (e.g., PACS), the fourth column, Transaction ID 726, identifies which transaction is used and the fifth column, Active 728, identifies whether the event identified in the first column 720 is active at a particular site. In the case where a particular installation does not support one or more events, the active flag is set to false to inform the system that a particular event never occurs.

The transaction definition database 720 has been referred to above and is now described as follows.

Referring now to FIG. 7b, the transaction definition database 720 is shown. The transaction definition database 720 defines the event transactions in terms of the discrete data elements that comprise the transactions as well as their data types and transformations required to keep the data compatible when exchanged between the various systems.

The transaction database 720 is built for each foreign system that will interact with a RIS for a particular installation. The transaction database 720 is built for each foreign system based on the system's requirements.

For example, a foreign system (e.g., PACS) requires that a transaction named LGN begin with a \hat{ }D and end with a \hat{ }T with each field defined as a string and each field separated from each other with a “|”. The foreign system further requires that the sequence of fields needs to be first the user name and then the password. All of this detail is published by the foreign system as documentation to assist developers who want to write an interface. Instead of writing a lot of single use code we will have a few re-usable routines and a lot of data definition. It is much easier to post data than it is to write code.

Referring to the transactions table 722 of database 720, there is shown in the first row 723, an exemplary logon transaction, LGN. Assume, for example, that a logon is required to be sent to a dictation system with a user name of “some username” and a password of “some password”. To do so, a LGN transaction needs to be created. A lookup is performed in the event map database 710 to find a corresponding transaction ID (e.g., LGN).

Next, knowing the Transaction ID, the format of the transaction must be determined. To do so, the transaction definition database 720 is referenced to find the set of all fields, in sequence, that have the transaction ID of LGN. In the present example, there are two.

Referring now to the transactions table 722 table of the transactions definition database 720, the first row 723 corresponds to the LGN transaction.

Each column of the transactions table is now described. The first column refers to the transaction Id=“LGN”, the next column, Active=Y, indicates that the logon transaction is used in the site specific system configuration, the Frame Start Delimiter ID=\hat{ }D, signifies the beginning of the transaction. This allows the common integration layer 32 to know when a transaction starts during a continuous stream of data. This field is a reference to a delimiter ID defined in the delimiters table 742. The Frame End Delimiter=\hat{ }D\hat{ }T, allows the common integration layer 32 to know when a transaction ends during a continuous stream of data. This field is also a reference to a delimiter ID defined in the delimiters table 742.

Referring now to the Fields table 744 of the transaction definition database 720, it is shown that two fields are appropriate for a LGN transaction. Both fields are security related for identifying the user and the user password.

The first row 746 of the fields table 744 identifies the user (see lines 1-4 below).
1. Transaction ID=LGN
2. Field Name=UserName
3. Field Datatype=string
4. Field sequence=1

The second row 748 of the fields table 744 corresponds to the user's password (see lines 5-8 below)
5. Transaction ID=LGN
6. Field Name=Password
7. FieldDatatype=string
8. Field sequence=2

The transaction definition database entry for the logon transaction entry (as shown in FIG. 7b) is:
Transaction ID=LGN
Active=Y
Frame Start Delimiter=1
Frame End Delimiter=2
Field Delimiter ID=3

Since there are two fields defined for transaction LGN (username and password) the transaction built by the common integration layer 32 from the data defined in the transaction database 720 is the intersection of the two fields:
\hat{ }DLGN|some username|some password|\hat{ }T (1)

The transaction that is built by the common integration layer 32, shown as (1), assembles data in a manner that signals the start of the transaction to a foreign system, and all of the fields in the proper format (e.g. data type) separated by the proper delimiters, and finally the data that signals the end of the transaction.

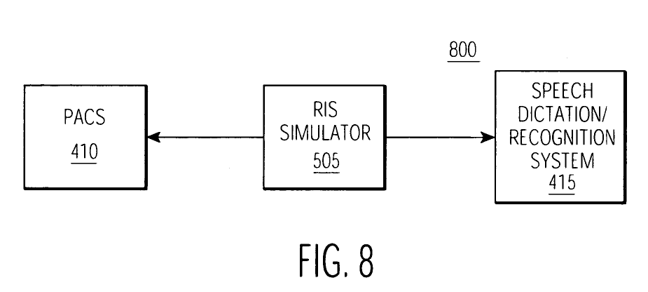

FIG. 8 illustrates a system configuration that includes an RIS Simulator 505 in place of an actual RIS 405. The RIS simulator 505 facilitates the testing of transactions prior to the installation of the actual RIS 405. This is a desirable feature in that installation of an actual RIS 405 is a lengthy and labor-intensive effort that can occupy several persons for several months. Having the ability to confirm that the integration between systems operates successfully in advance of the completion of a RIS installation greatly decreases the time required to provide workflow integration between systems linked to an actual RIS 405. RIS simulator 34 also provides configuration and tracing tools for debugging and quality

Once the local configuration based on the event map database 710 and the transaction definition database 720 is complete, RIS simulator 34 allows for the generation of events, the confirmation of the exchange of transactions and the transformation of data as if an actual RIS 405 installation were complete.

By way of example, RIS simulator 505 is now described in the context of the “RIS drives PACS” workflow configuration 800 of FIG. 8 and the “logon and first procedure access” workflow diagram of FIG. 5.

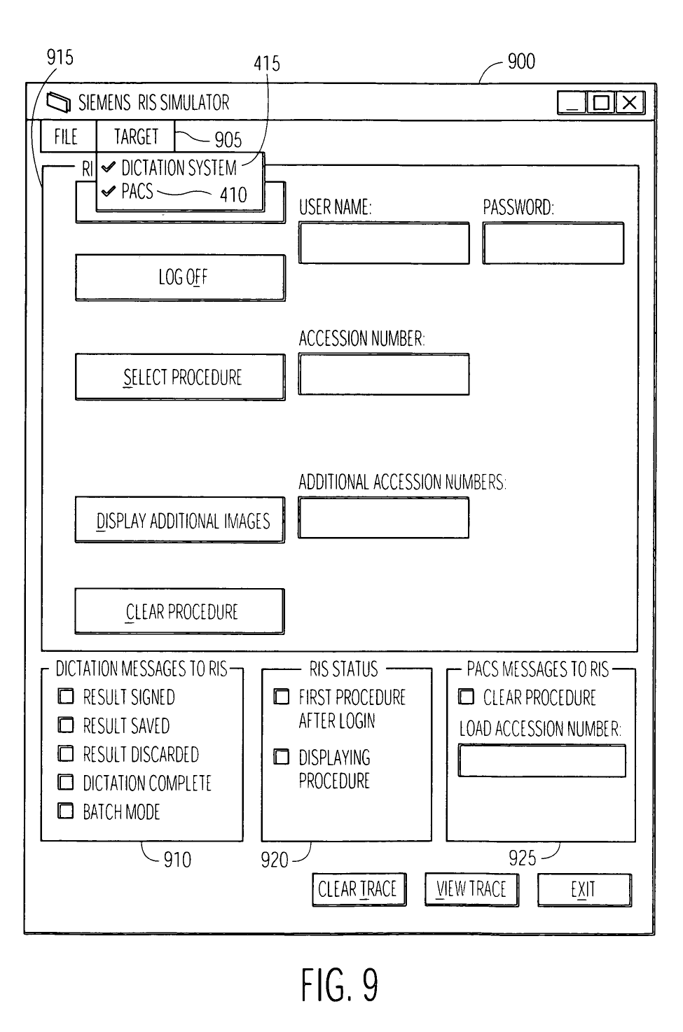

FIG. 9 is a display image window of one embodiment of an RIS simulator display screen 900 which is displayed in response to user command.

It should be appreciated that RIS simulator 505 sends messages as if they came from the RIS 405 itself. The prompts and buttons in the “RIS Actions” frame 915 are used to generate these messages.

A typical first step in the use of RIS simulator 505 is to determine which systems are actually interacting at a particular installation site. The display screen 900 shows that RIS simulator 505 is configured to exchange transactions between a PACS 410 and a Speech Dictation/Recognition system 415, as indicated in the “Target” drop down menu 905.

The RIS simulator 505 has a capability to receive and validate messages received from foreign systems (e.g., PACS, Speech Dictation/Recognition). The results of messages received from a dictation system appear in the “Dictation Messages to RIS” frame. The results of messages received from a PACS 410 appear in the “RIS Actions” 915 and “PACS Messages to RIS” 925 frames.

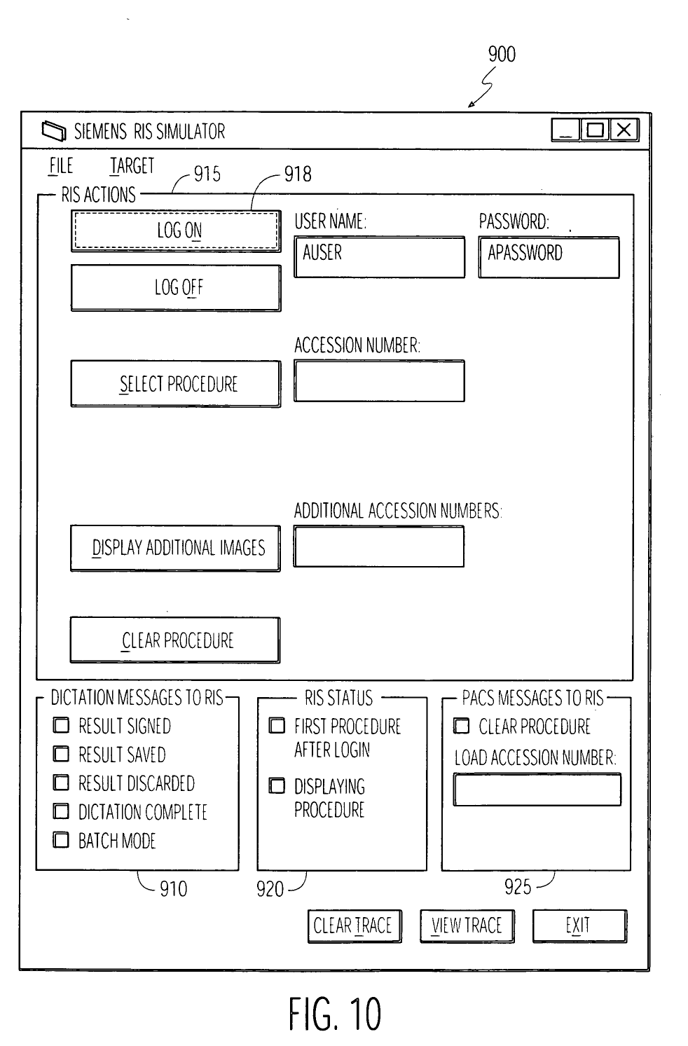

FIG. 10 is the display image window 900 of FIG. 9 further illustrating how various messages are sent from RIS simulator 505 to the PACS 410 and the Speech Dictation/Recognition System 415.

As a first example, a Logon Message is sent from RIS simulator 505 to the PACS 410. This action tests the Logon message, i.e., “LogOn” 80, sent from the RIS 405 to the PACS 410 in the “RIS drives PACS” workflow “logon and first procedure access” workflow diagram of FIG. 5. The “LogOn” button 918 is shown in outlined indicating that the button has focus and is ready to be clicked.

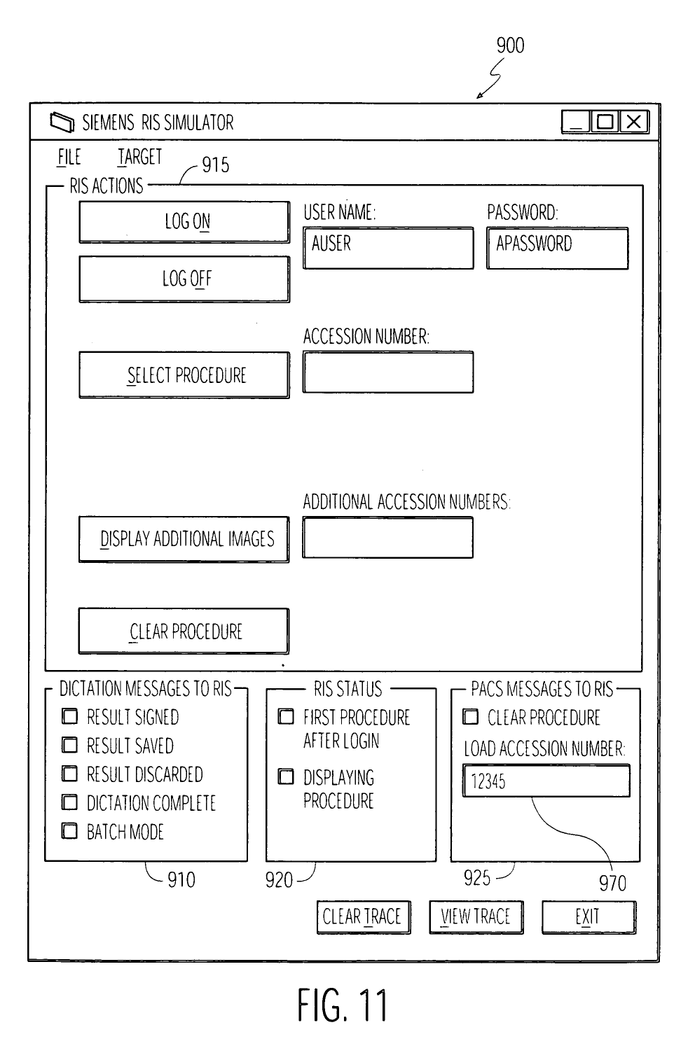

FIG. 11 is the display image window 900 of FIG. 9 further illustrating how various messages are received by RIS Simulator 505 from the PACS 410 and the Dictation System 415. In the illustrative example, RIS simulator 505 has received a “Logon” and a “ShowProcedure” message from the PACS. The semantics of the message convey a procedure identifier (accession number) and, in response, RIS simulator 34 shows that identifier in the “Load Accession Number:” display entry area 970.

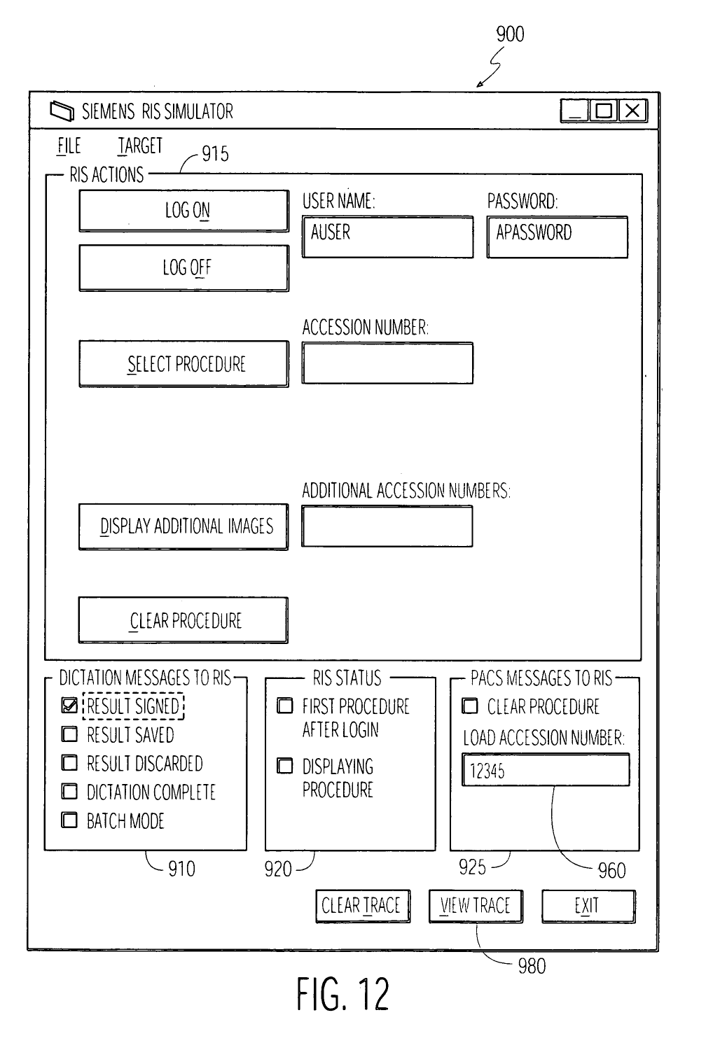

FIG. 12 is the display image window 900 of FIG. 9 further illustrating a case in which the RIS simulator 505 has received additional messages from the speech dictation/recognition system 415. The dictation system message results appear in the “RIS Actions” 915 and “Dictation Messages to RIS” 910 frames. In the present illustrative example, the speech dictation/recognition system 415 has signed a result for accession number 12345 as illustrated in the Load Accession Number entry box 960. This means that the radiologist has dictated a result on the speech dictation/recognition system 415 and has signified that the result text is complete and correct.

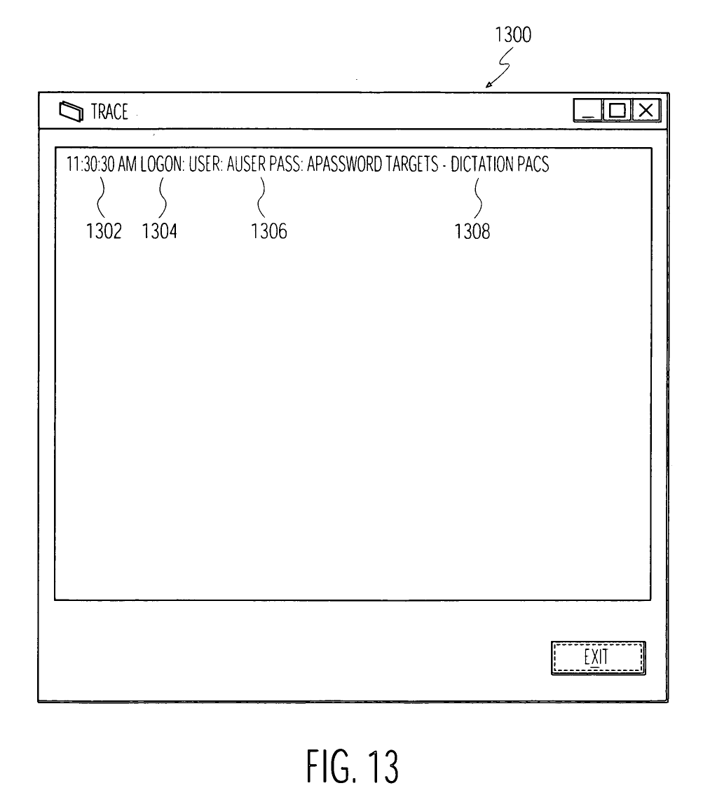

FIG. 13 is a display image window of one embodiment of a trace screen 1300 that is shown to a user in response to the user clicking on the “View Trace” icon 980 of FIG. 12. For messages sent by RIS simulator 505, FIG. 13 reveals detailed data trace displaying the time 1302, message type 1304, data 1306, and targets of messages 1308. For messages received by RIS simulator 505, the trace data (not shown) includes time, message type, data, and message source.

In the present example, RIS simulator 505 has sent a “Logon” message to a PACS 410 and a speech dictation/recognition system 415. The display of FIG. 13 allows for confirmation as to whether the sequence of events and the transactions sent to represent those events is correct.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A system supporting message communication between healthcare information systems employing different communication message data formats, comprising:
a communication processor for,
receiving a message from a first information system in a first data format,
identifying a type of said received message,
selecting a particular message data format and a message destination from a plurality of message destinations based on said determined type and based on a source of said received message,
converting data in said received message in said first data format to a different second data format for communication via a communication interface to a destination information system, and
communicating said converted data in said different second data format to said destination information system.

2. A system according to claim 1, wherein said communication processor includes a common integration layer.

3. A system according to claim 1, including
a repository of information identifying a plurality of different message data formats associated with a corresponding plurality of different healthcare information system communication interfaces and wherein
said communication processor selects said particular message data format and said destination, using said repository.

4. A system according to claim 3, including
said communication processor selects a plurality of message data formats compatible with a corresponding plurality of different destination information systems and converts data in said received message in said first data format to a plurality of different data formats compatible with said plurality of different destination information systems and communicates said converted data in said different data formats to said plurality of different destination information systems.

5. A system according to claim 1, wherein
said communication processor selects said message destination from a plurality of message destinations in response to predetermined information identifying a workflow task sequence indicating a particular task and associated destination for at least one of, (a) said message type and (b) said message source.

6. A system supporting message communication between healthcare information systems employing different communication message data formats, comprising:
a communication processor for,
receiving a message via a first information system communication interface in a first data format,
identifying a type of said received message,
selecting a particular message data format and a message destination information system communication interface based on said determined type,
converting data in said received message in said first data format to a different second data format for communication via said destination information system communication interface, and
communicating said converted data in said different second data format to said destination information system.

7. A system according to claim 6, wherein said communication processor includes a common integration layer.

8. A system according to claim 6, wherein
said communication processor selects a plurality of message communication interfaces of a plurality of destination information systems, based on said determined type, converts said data in said received message to different data formats for communication via said plurality of destination information system communication interfaces, and communicates said converted data in said different data formats to said destination information systems.

9. A system according to claim 6, wherein
said message type comprises at least one of, (a) a command type, (b) a data type, (c) a message data format type, (d) a message source and (e) a message destination.

10. A system according to claim 6, including
a healthcare information system simulator for receiving and processing said converted data in said different second data format and for providing a response indicative of whether said converted data is compatible with a healthcare information system.

11. A system according to claim 10, including
a command processor responsive to at least one of, (a) predetermined stored instruction and (b) user command, for initiating a test of said communication processor and performing a sequence of operations using said simulator.

12. A system according to claim 6, including
a healthcare information system simulator including at least one of, (a) said information repository and (b) said communication processor.

13. A system according to claim 6, including
a repository of information identifying a plurality of different message data formats associated with a corresponding plurality of different healthcare information system communication interfaces and wherein
said communication processor selects said particular message data format and said message destination information system communication interface based on said determined type, using said repository.

14. A system according to claim 13, wherein
said information repository contains information identifying a plurality of different communication channels supporting communication between executable applications operating on different healthcare information systems.

15. A system according to claim 14, wherein
said plurality of different communication channels comprise Microsoft compatible named channels.

16. A system according to claim 6, wherein
a healthcare information system is at least one of, (a) a Radiology Information System (RIS), (b) a Picture Archiving and Communication System (PACS) and (c) a dictation system.

17. A system supporting message communication between healthcare information systems employing different communication message data formats, comprising:
a repository of information identifying a plurality of different message data formats associated with a corresponding plurality of different healthcare information system communication interfaces; and
a communication processor for,
receiving a message via a first information system communication interface in a first data format,
identifying a type of said received message,
selecting a particular message data format and a message destination information system communication interface based on said determined type,
converting data in said received message in said first data format to a different second data format for communication via said destination information system communication interface, and
communicating said converted data in said different second data format to said destination information system.

18. A system according to claim 17, wherein said communication processor includes a common integration layer.

19. A system supporting message communication between healthcare information systems employing different communication message data formats, comprising:
a communication processor for,
receiving a message from a first information system in a first data format,
identifying a type of said received message,
selecting a particular message data format and a message destination from a plurality of message destinations based on said determined type and based on a source of said received message,
converting data in said received message in said first data format to a different second data format; and
a healthcare information system simulator for receiving and processing said converted data in said different second data format and for providing a response indicative of whether said converted data is compatible with a particular healthcare information system.

20. A system according to claim 19, including
a command processor responsive to at least one of, (a) predetermined stored instruction and (b) user command, for initiating a test of said communication processor and performing a sequence of operations using said simulator.

21. A method for providing message communication between healthcare information systems employing different communication message data formats, comprising the activities of:
receiving a message from a first information system in a first data format;
identifying a type of said received message;
selecting a particular message data format and a message destination from a plurality of message destinations based on said determined type and based on a source of said received message;
converting data in said received message in said first data format to a different second data format for communication via a communication interface to a destination information system; and
communicating said converted data in said different second data format to said destination information system.

22. A method for providing message communication between healthcare information systems employing different communication message data formats, comprising the activities of:
receiving a message from a first information system in a first data format;
identifying a type of said received message;
selecting a particular message data format and a message destination from a plurality of message destinations based on said determined type and based on a source of said received message;
converting data in said received message in said first data format to a different second data format; and
simulating a healthcare information system response by receiving and processing said converted data in said different second data format to provide a response indicative of whether said converted data is compatible with a particular healthcare information system.

23. A method for providing message communication between healthcare information systems employing different communication message data formats, comprising the activities of:
receiving a message via a first information system communication interface in a first data format;
identifying a type of said received message;
selecting a particular message data format and a message destination information system communication interface based on said determined type;
converting data in said received message in said first data format to a different second data format for communication via said destination information system communication interface; and communicating said converted data in said different second data format to said destination information system.
